(19) United States
(12) Patent Application Publication
(10) Pub. No.: US 2004/0163317 A1
(43) Pub. Date: Aug. 26, 2004

(54) Fitting for lift-slide doors or windows and lift-slide door or window with such a fitting

(76) Inventors: Winfried Reich, Ditzingen (DE); Udo Dieners, Grossbottwar (DE); Frank Beisswenger, Weil der Stadt (DE)

Correspondence Address: Hoffman, Wasson & Gitler, P.C., Suite 522, 2361 Jefferson Davis Highway, Arlington, VA, 22202, US

(21) Appl. No.: 10/690,846

(22) Filed: Oct. 23, 2003

(30) Foreign Application Priority Data
Jan. 10, 2003 (DE) 203 00 403.5
Mar. 13, 2003 (DE) 203 04 001.5
Aug. 22, 2003 (DE) 203 13 145.2

(51) Int. Cl. E05D 15/06

(52) U.S. Cl. 49/209; 49/216; 49/226

(57) ABSTRACT

The invention pertains to a new type of fitting for lift-slide doors or windows with at least one running shoe located on a bearing element so that it can be moved in a longitudinal running shoe axis relative to the bearing element for raising and lowering the door or window sash and with a coupling element that connects the at least one running shoe for this movement with a drive element, for example with a push rod, located on one vertical section of the sash frame.

The invention pertains to a fitting for lift-slide doors or windows as claimed in the preamble of claim 1, 3 or 23 and to a lift-slide door or a lift-slide window as claimed in the preamble of claim 26.

Lift-slide doors or lift-slide windows and suitable fittings for these doors or windows are known in the art. The basic function of such doors or windows is that the respective door or window casement or sash or inner frame can be raised and lowered relative to an outer frame and at the same time can be moved in the sash plane, so that for example when opening the closed sash it is first raised vertically and then moved horizontally. The sash is closed in the reverse manner. As a further function, lift-slide doors in particular can be equipped with a tilt function.

Also known in the art is to provide a manually operated gear unit (DE 78 16 563 U1) on a vertical sash frame element forming the opening and closing side of the sash, which especially for raising and lowering is connected by means of a drive connection with running carriages or running shoes located on the bottom of the sash by means of a drive or push rod fitting or by means of a push rod located on a lock or forend rail and a corner guide or transmission. During manual actuation of the gear unit the push rod is moved, causing the running carriage or running shoe of the fitting to move in the longitudinal running shoe direction relative to a bearing element located on the lower horizontal bar or shank of the sash. By means of a diagonally positioned inclined slot/pin guide between the running shoe and the bearing element this results in a change in distance between the running shoe and the lower horizontal shank of the sash, thus raising or lowering the sash relative to the outer window or door frame. The vertical movement first produced via the gear unit by actuating the hand lever must be transferred from a push rod located on one vertical side of the sash frame into a horizontal movement. In the known fitting, this is achieved by means of a two-armed lever, also referred to as a bell lever and which can swivel on bearings on an axis perpendicular to the plane of the sash, namely on a bearing element of the fitting, which is mounted in the channel or rebate of the sash at the corner area between the vertical and the lower horizontal shank or section of the sash frame.

For fastening the forend rail with its push rod and for holding the corner transmission and the running carriage, and also for accommodating other guide and fitting elements, grooves (mounting grooves) are located on the periphery or in the rebate of the sash frame, however with a different design on the individual sash frame elements.

A further disadvantage of this known fitting is that the corner transmission formed by the two-armed lever requires a relatively large amount of space in the sash, which is achieved by means of an accordingly deep groove in the rebate area (mounting groove). This deep groove weakens the sash and therefore at least is a hindrance to the requirement for maximum protection against intrusion.

For sash frames made of wood, the different form of the grooves on the sash frame elements requires the use of different routing machines or the changing of tools, while for sash frames made of plastic, different extrusion tools are necessary for the manufacture of the sash frame profiles, which increases the time and costs of manufacturing.

Furthermore, the forend rails until now used for lift-slide doors or lift-slide windows are generally U-shaped forend rails, which guide the movement of the respective push rod between its legs and are supported on the bottom of the groove with the free edges of their legs. The disadvantage of this is that such U-shaped forend rails are bulky, heavy and expensive and, moreover, require a relatively wide groove (mounting groove) in the rebate area, caused on the one hand by the additional thickness of the material of the legs and in particular also caused by the use of the manually actuated gear unit, in which the U-shaped forend rail must overlap the casing of this gear unit.

Known in the art are also fittings in which the corner transmission consists of several lamellar stacked spring steel bands (DE 34 40 505) or is formed by a chain (DE 72 44 800). The disadvantage of these designs is the fact that the transfer of drive or pressure forces is insufficient and for this reason the lowering movement of the sash must be supported at least by the weight of this sash. The latter decreases the design possibilities for the lifting curve formed between the running shoe and the respective bearing element.

Known in the art is also the use of a multi-part running carriage or running shoe casing for lift-slide fittings, namely with two side panels or walls, between which the rollers of the running shoe can turn on bearings. This design is likewise relatively expensive to manufacture.

The object of the invention is to present a fitting (push rod fitting) that can be manufactured especially inexpensively while maintaining reliable functionality and that also enables a reduction of the width and/or depth of the mounting groove. To achieve this object, a fitting according to claim 1, 3 or 23 is embodied. A lift-slide door or a lift-slide window according to claim 26 is embodied.

In the first general embodiment of the invention the corner transmission is made of a rigid, rod-like or push/pull type coupling element, which can slide in the bearing element. A bell-shaped, two-armed lever and the disadvantages associated with the same, in particular the additional cost of manufacturing and the relatively large space required for mounting, are thus eliminated. The rod-like or push/pull type design of the coupling element enables it to transfer both pulling and pushing forces reliably to the running shoe.

In a further general embodiment of the invention, the casing of the respective running shoe is made of one piece, preferably of die-cast metal, for example die-cast zinc. This results in a reduction of the number of individual parts of the fitting and a significant reduction of the manufacturing costs.

The invention is explained below with reference to the drawings based on a sample embodiment.

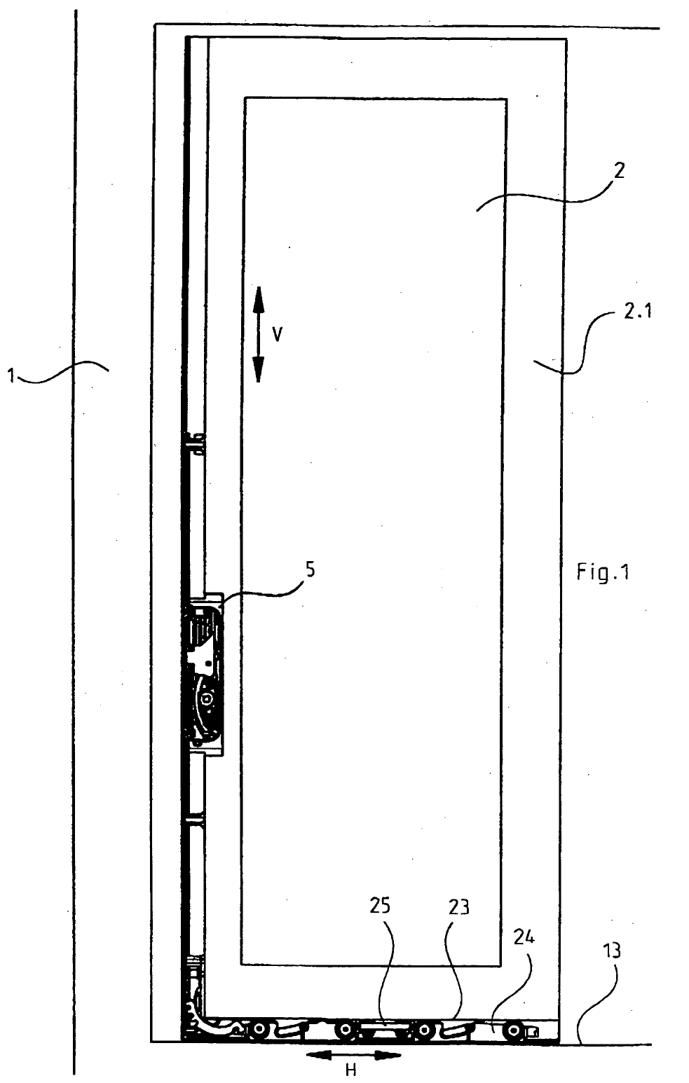

FIG. 1 shows a partial representation of the front view of a lift-slide door;

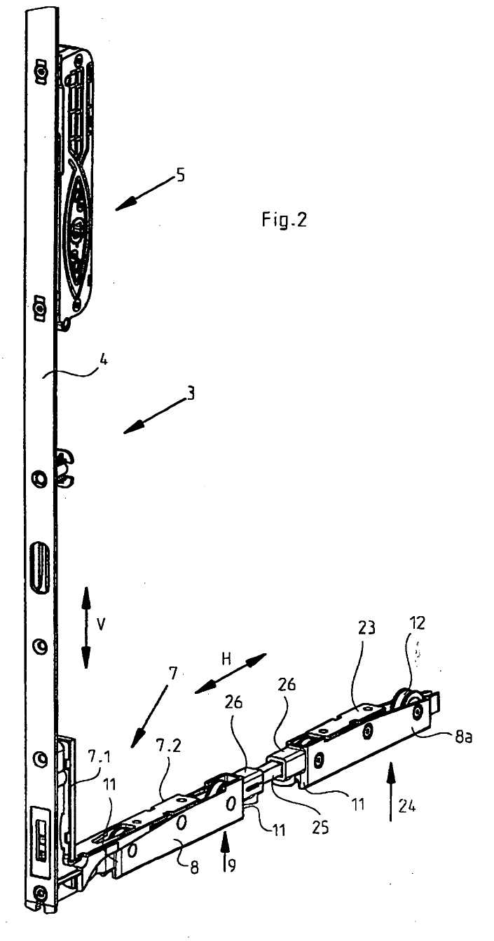

FIG. 2 shows a detail representation of the life/slide fitting for the door in FIG. 1;

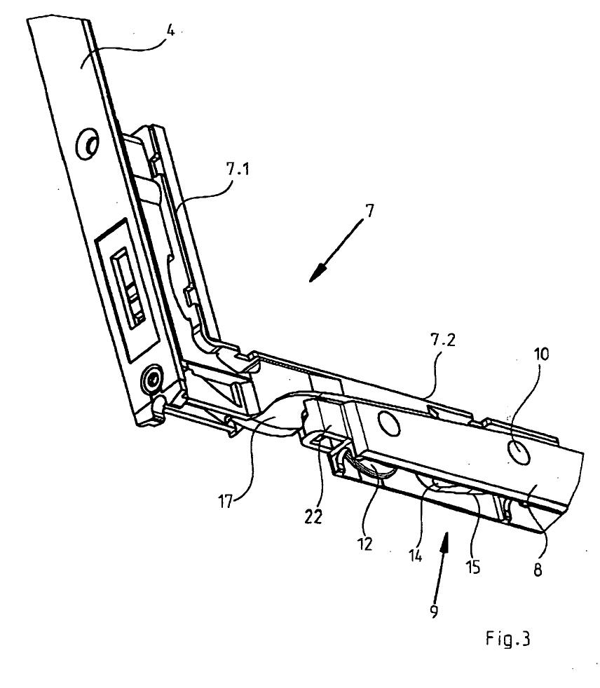

FIG. 3 shows a perspective representation of the fitting of FIG. 2 in the area of the corner transmission;

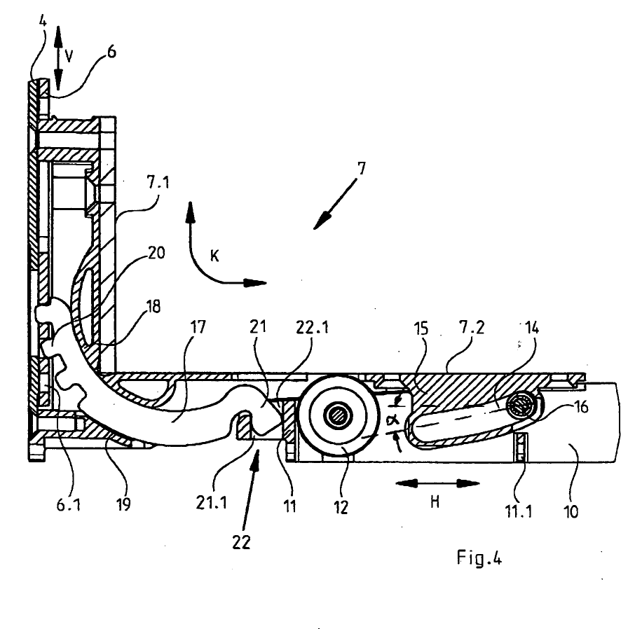

FIG. 4 shows the fitting of FIG. 2 in the area of the corner transmission, but in cross section;

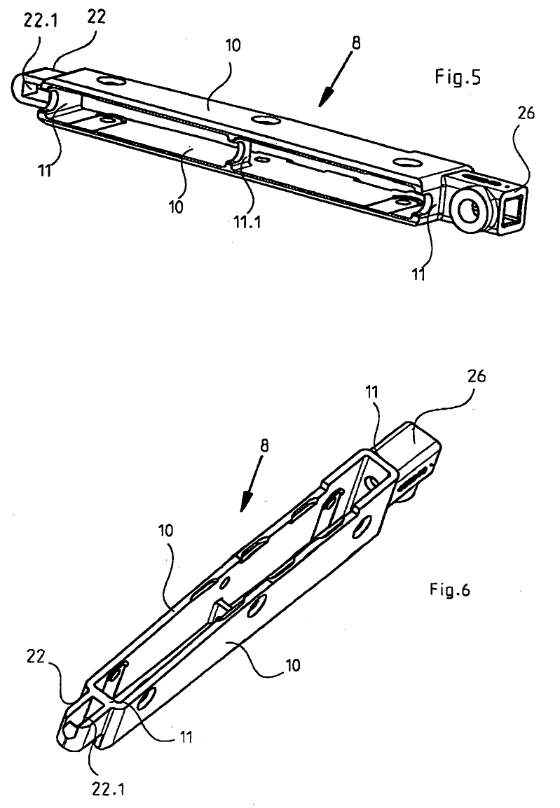

FIGS. 5 and 6 show different perspective views of the one-piece die-cast zinc running shoe casing of the running shoe of the fitting in FIG. 1;

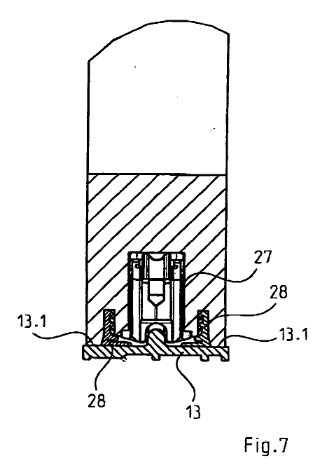

FIG. 7 shows a cross section of the lower shank of a sash frame in the area of a running carriage;

FIG. 8 shows cross sections of connecting rods for connecting two running shoes, with circular and square profiles;

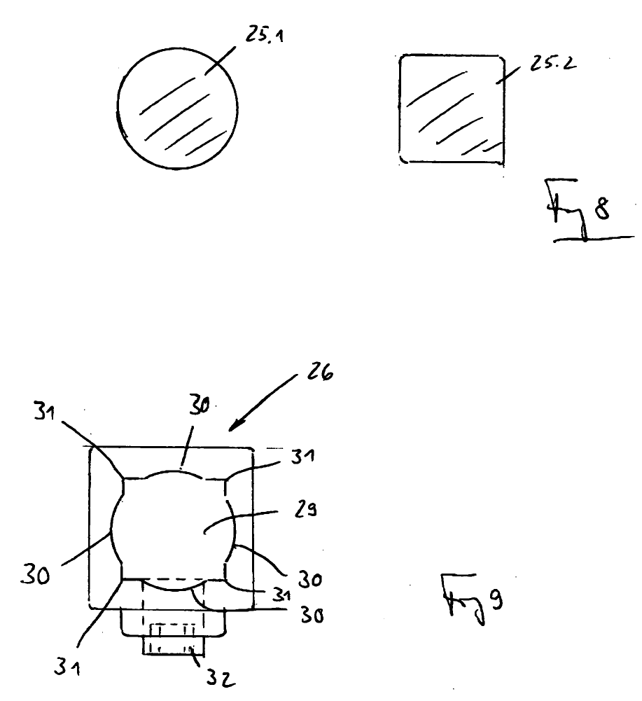

FIG. 9 shows a cross section of a coupling section molded onto a running shoe casing for the optional use of a connecting rod with a circular or square profile;

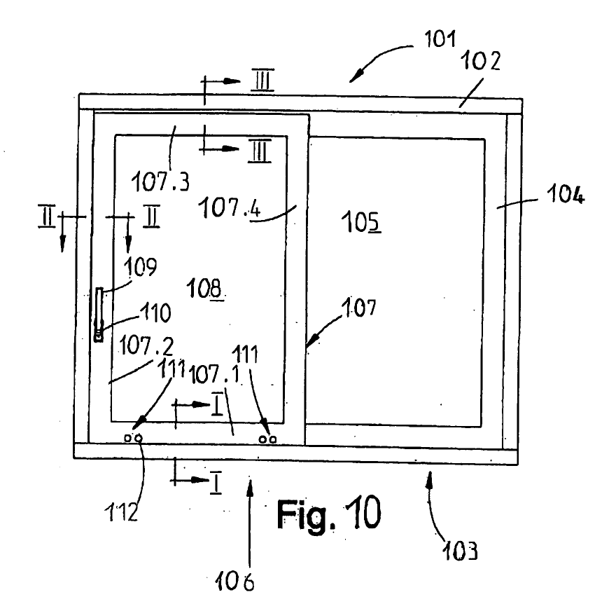

FIG. 10 again shows a simplified representation of a door of a building with a lift-slide sash and a fixed field;

FIG. 11 shows a partial representation of the lower, horizontal shank or the lower sash frame element of the sash corresponding to line I-I of FIG. 10 for a sash frame made of wood;

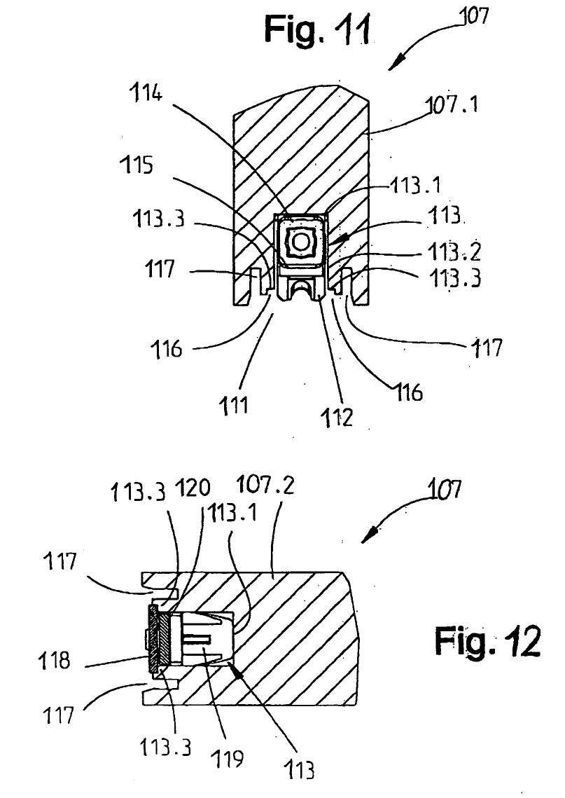

FIG. 12 shows a cross section of the vertical sash frame element of the sash on the gear unit side corresponding to line II-II of FIG. 10 for a sash frame made of wood;

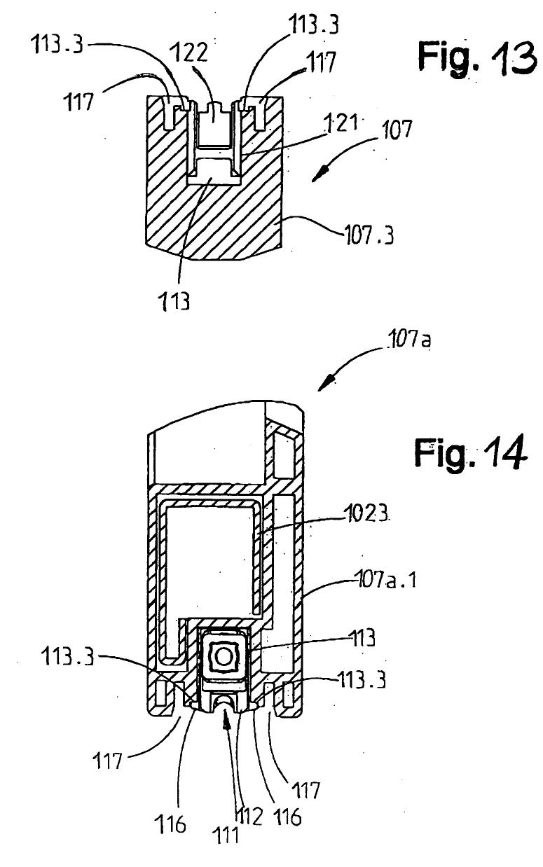

FIG. 13 shows a cross section of the upper horizontal sash frame element of the sash corresponding to line III-III of FIG. 10 for a sash frame made of wood;

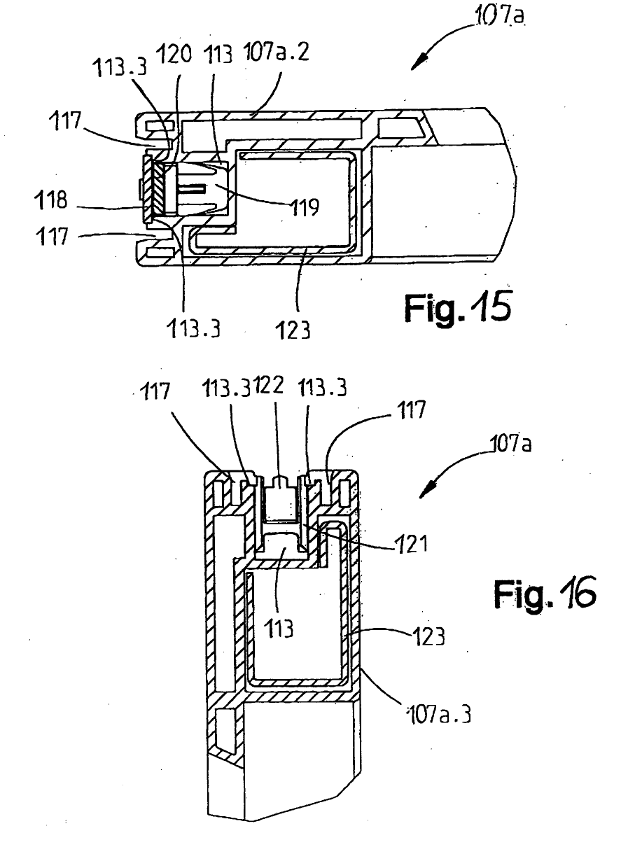

FIGS. 14-16 show cross sections corresponding to FIGS. 11-13, however for a sash frame made of plastic.

FIG. 1 shows a door of a building, which as a lift-slide door consists in the known manner of the outer door frame 1 and the inner door sash 2 located in this outer frame, which sash is embodied for example with an additional tilt function and, i.e. for opening and closing, can be raised and lowered vertically and can slide and also be tilted.

The lift-slide fitting, generally designated 3 in the drawings, is located in the known manner on the sash 2 or on its sash frame and contains, e.g., the forend rail 4 fastened to a vertical rebate of the sash frame 2.1, the lifting gear 5 there that can be actuated with a handle not depicted and the drive or push rod 6 that can slide axially on the forend rail 4 (double arrow V) and is driven by the gear unit 5. The lower end of the forend rail 4 in FIGS. 2, 3 and 4 is connected with a leg 7.1 of an angled bearing element 7, which is made of a suitable material, for example of plastic or metal.

The bearing element 7 is connected at the leg 7.1, which in mounted condition of the fitting 3 is oriented vertically, with the forend rail 4, for example by means of screws or rivets. A further leg 7.2 of the bearing element 7, which is located on the lower horizontal shank or element of the door sash frame 2.1 when the fitting 3 is in mounted condition, forms the bearing for the casing 8 of a running shoe 9.

The casing 8 in the depicted embodiment is made of one piece of a suitable material, for example of metal, e.g. as a die-cast metal part (die-cast zinc part), with two parallel casing walls 10 that extend in the longitudinal direction of the running shoe and are connected with each other on both ends of the casing by corresponding walls 11. Between the two ends the walls 10 are connected with each other by means of additional reinforcement walls 11.1.

In the casing 8 in the depicted embodiment there are two rollers 12 that turn freely on bearings, on axes perpendicular to the plane of the door sash 2. The rollers 12 engage in the known manner with a guide rail 13 located on the lower element of the frame 1 and are made of metal, for example.

For raising and lowering the door sash 2 there is a diagonal lifting curve on the leg 7.2, in the form of a diagonally extending, elongated opening 14, which forms an acute angle with the longitudinal extension of the leg 7.2. The opening 14 located on a projection 15 that is contained between the walls 10 extends from the side of the leg 7.2 adjacent to the door sash into the casing 8 of the running shoe and forms lateral guide surfaces for the inner surfaces of the longitudinal walls 10. The projection 15 contained between the two walls 10 causes the running shoe 9 to be guided positively on the bearing element 7. A guide bolt 16 connecting these walls 10 is inserted into the opening 14.

Moving the running shoe 8 axially (double arrow H) relative to the bearing element 7 raises and lowers the door sash 2. This movement is effected by means of the push rod 6 by manually actuating the gear unit 5.

For the drive connection between the push rod 6 and the running shoe 9 there is a coupling element 17, which is designed as a rigid push/pull element and in the depicted embodiment is part of an arc or a ring. For the coupling element 17, an arc-shaped guide is formed from wall sections 18 and 19 in the bearing element 7 in the area of the corner between the legs 7.1 and 7.2, such that the coupling element 17 can be moved in this guide on an arc on an axis perpendicular to the plane of the door sash (double arrow K).

On one end the coupling element 17 is provided on the outer side, i.e. the convexly curved side, with several teeth 20 forming a gear. This gear engages in openings 6.1 on the lower end of the push rod 6, so that when the push rod 6 is moved axially (double arrow V), the coupling element 17 executes a longitudinal movement in the form of a circular movement corresponding to the double arrow K.

The end of the coupling element 17 furthest from the teeth 20 is connected by means of a jointed connection with the end of the running shoe 6 adjacent to this coupling element, due to the fact that the corresponding end engages with a hook-shaped section 21 in an opening 22.1 of an eyelet section 22 located on the front wall 11. As shown especially in FIG. 4, the coupling element 17 engages with its section 21 from above in the recess 22.1 of the eyelet section 22, thereby extending behind an edge of the eyelet section 22 with a rounded surface 21.1 molded onto the section 21. The embodiment is furthermore designed so that the section 21 is guided on two side surfaces on surfaces within the recess 22.1 offset against each other in an axis direction perpendicular to the sash plane and parallel to the rotation axis of the rolls 12, which stabilizes the movements of the coupling element 17 and of the running shoe 9 during raising and lowering of the door sash 2.

As further shown especially in FIG. 4, the axis of the circular movement of the coupling element 17 is within the angle formed by the legs 7.1 and 7.2, perpendicular to a plane that is defined by the longitudinal axes of these legs.

With the coupling element 17, the fitting 3 eliminates the prior art swiveling guide bell of lift-slide fittings. This results in a very simple and reliable construction. The design of the coupling element 17 on the one end as an arc-shaped curved toothed rod ensures a reliable drive connection between the push rod 6 and the coupling element 17 and the running shoe 9, namely a drive connection via which both pulling forces for raising the door sash and pushing forces for lowering the door sash 2 can be effectively transferred. A further advantage of the guide using the coupling element 17 is that the bearing element 7 can be kept very small also in the area of this guide, thus reducing the space needed for installation in the door sash 2.

As shown in FIG. 1, a further running shoe 24 is located on the lower, horizontal section of the sash frame 2.1 on a further bearing element 23, in the area of the second lower corner of the sash frame 2.1 furthest away from the bearing element 7. The bearing element 23 is designed similarly to the leg 7.2 of the bearing element 7. The running shoe 24 corresponds to the running shoe 9. Both running shoes 9 and 24 are connected with each other in the known manner by means of a connection 25, which is suitable for the transfer of push and pull forces. This connection 25 is, for example, a connecting rod, which is fastened at the ends to the running shoes 9 and 24, namely by engaging in sleeve-like coupling or connection sections 26, that are molded onto the respective running shoe casing 8 or 8a on the front, i.e. in the area of the front wall 11.

The running shoe casing 8a of the running shoe 24 differs from the running shoe casing 8 only in that there is a coupling section 26 on the two front walls 11 of the running shoe casing 8a.

FIG. 7 shows the bearing element 7 and the leg 7.2 in installed condition. The latter is contained together with the running shoe 9 in a groove 27 located on the bottom of the door sash. On both sides of the groove there are seals 28 on the bottom of the door sash that extend along the entire width of this door sash and bear against the seal surface 13.1 of the guide rail 13 when the door sash 2 is lowered, i.e. closed.

FIG. 8 shows a cross section of a connection 25 and a connecting rod 25.1 with a circular profile and a connecting rod 25.2 with a square profile, which can alternately be used as a connection 25. The profiles of the two connecting rods are adapted to each other so that the diagonal of the profile of the square connecting rod 25.2 is somewhat greater than the diameter or twice the radius of the profile of the connecting rod 25.1.

In order to alternately use both connecting rods 25.1 and 25.2, the coupling section 26 molded onto or integral formed with the respective end of the running shoe casing 8 or 8a has an opening 29, the shape of which first corresponds to a square profile, combined with a circular profile in a manner that each of the four sides of the profile contains one cylindrical curved area 30 corresponding to the round profile and these areas 30, which are curved on the common middle axis of the sleeve opening 29, are designed so that the corner areas 31 receive the square profile, i.e. that adjacent right-angle surfaces are present there. This means that the radius of curvature of the curved areas 30 is smaller than half the distance between two diagonally opposed corner areas 31.

For connecting two running shoes, for example running shoes 9 and 24, the respective connecting rod 25.1 or 25.2 is inserted with one end into the opening 29 of a sleeve-like coupling section 26 on the running shoe casing 8 or 8a and then clamped tight with fixing means located on this coupling section 26, for example with clamping screws 32.

For the connecting rods 25.1 and 25.2, inexpensive, commercially available rods made of metal, for example of steel, can be used. The overall diameter of these connecting rods can be kept relatively small, since in practice the respective connection 25 or connecting rod 25.1 or 25.2 is subjected primarily to a tensile force. This results from the design of the lifting curves 16 on the bearing elements 7 and 23. The longitudinal extension of the respective lifting curve forms an acute angle á with the horizontal (axis direction of the double arrow H), i.e. an angle á smaller than 90° (FIG. 4), which in the running shoe 9 opens toward corner transmission 7 and in the running shoe 24 opens from the running shoe 9. This course of the lifting curve results in the tensile force in the connection 25 due to the weight of the door sash 3. There are no pressure forces in this connection.

In FIGS. 6-10, a door of a building designated 101 likewise comprises an outer door frame 102, a fixed field 103 with the corresponding frame 104 in this door frame and the corresponding glass 105, in addition to a sash 106, which is designed as a lift-slide sash.

The sash 106 consists of the sash frame 107, which contains the glass 108, and of four sash frame elements connected with each other at right angles and made of a sash frame profile, e.g. wood, namely the lower horizontal sash frame element 107.1, the vertical sash frame element 107.2 forming the opening or gear side of the sash 106, the upper horizontal sash frame element 107.3 and the other vertical sash frame element 107.4.

In the sash frame element 107.2 there is a gear unit 110 with a hand lever 109, with which it is possible to lock and unlock the sash 106 in closed position by means of a push rod fitting in the rebate of the sash frame 107 also on the door frame 102, and to raise and lower the sash 106 for opening and closing.

To open the door 101, the sash 106 in raised position can be moved horizontally, parallel to its sash plane or parallel to the plane of the fixed field 103. For this purpose, in the depicted embodiment there are two running shoes or running carriages 111 on the lower horizontal sash frame element 107.1 that are only schematically indicated in FIG. 10 with their rollers 112 and that are guided in a horizontal guide rail by means of these rollers 112. For raising and lowering the sash 106 the two running carriages 111 are provided with suitable lifting means that can be actuated via the push rod fitting.

FIG. 11 shows a simplified representation of the lower horizontal sash frame element 107.1 in a sash frame 107 made of wood. This sash frame element is provided on the bottom side with a groove 113, which is open toward the bottom of the sash frame element 107.1 and in the depicted embodiment lies with its middle plane in the vertical middle plane of the sash frame element 107.1. The groove 113 serves to hold the running carriages 111, which are offset against each other in this groove in the longitudinal direction of the sash frame element 107.1, but connected with each other via a drive connection for raising and lowering the sash 106. Each running carriage 111 is fastened to a running carriage support 114 on the bottom 113.1 of the groove 113 in a suitable manner, for example by a screw connection. The running carriage rollers 112 can rotate freely on bearings on a running carriage or running shoe casing 115. For raising and lowering the sash 106, the running carriage casing 115 is connected with the running carriage support by means of the lifting means, which in the simplest case consist of a lifting curve on the running carriage support 114 and a guide bolt on the running carriage casing 115 that works together with this lifting curve.

The depth of the groove 113 is such that at least when the sash 106 is in lowered position, the running carriage 111 with all its elements, including its running carriage rollers 112 are nearly completely contained in the groove 113. The groove 113 is somewhat widened on its open side, i.e. it is provided with a recess 116 on both sides, so that each side surface 113.2 of the groove in the area of these recesses forms a stage with a surface 113.3, which lies in a plane perpendicular to the middle plane of the groove 113.

On both sides of the groove 113 there are two additional grooves 117 in the sash frame element 107.1 or in the corresponding wooden profile, namely for holding seals, not depicted, to seal the closed sash 106 against the frame 102.

FIG. 12 shows a cross section of the vertical sash frame element 107.2 of the sash frame 107 made of wood. The sash frame element 107.2 likewise is provided with the groove 113 with the two recesses 116 and the additional grooves 117 for the seals, located on the rebate or on the outer side of the sash frame 107 adjacent to the frame 102 when the sash 106 is in closed position. The groove 113 in this case serves to fasten the forend rail 118 of the above-mentioned push rod fitting. The forend rail 118 is designed as a flat, strip-like rail and anchored by means of suitable fastening elements 119 in the groove 113, such that the forend rail 118 on its side facing the groove 113 in an edge area of its longitudinal sides bears against the surfaces 113.3 formed by the recesses 116 and covers the groove 113 toward the outside. Within the groove 113, a likewise strip-like push rod 120 can slide on the forend rail 118 in longitudinal direction. The push rod 120 is connected with the gear unit 110 via a drive connection in order to control, e.g. by means of a corner transmission not depicted, the running carriage 111 for raising and lowering the sash 106, as is known in the art, for example, from DE 203 04 001 U.

The two recesses 116 and the contact surfaces 113.3 formed by these recesses enable a strip-like design of the forend rail 118 that can nevertheless be fastened reliably and precisely to the sash frame 107 in the area of the groove 113.

The strip-like design of the forend rail 118, in addition to reducing material and costs, also features in particular the advantage that the groove 113 at least outside of the recesses 116, i.e. over the greater part of its depth, can be relatively narrow, i.e. the groove width can be reduced from the present usual width of approximately 22 mm to approximately 16 mm, which with the same outer dimensions of the wood profile used for the sash frame 107 results in a significant increase in the stability of the sash frame 107 and therefore, e.g. an increase in protection against intrusion, or a more compact design, in particular through reduction of the dimensions of the profile used for the sash frame 107.

FIG. 13 shows a cross section of the upper horizontal sash frame element. In this figure the groove 113 is likewise provided with the two recesses 116, together with the grooves 117 located on both sides of the groove 113 for the seal. An H-shaped profile is inserted in the groove 113 on the sash frame element 107.3 and fastened in a suitable manner. A guide element 122 is attached elastically in one piece to the profile 121 and is used to guide the sash 106 on its top side, i.e. with its sash frame element 107.3 on the door frame 102 for raising and lowering and also for sliding the sash.

As shown in FIGS. 11-13, the groove 113 required for holding the functional elements is identical in all sash frame elements 107.1, 107.2 and 107.3, which likewise means a significant simplification and reduction of costs during manufacturing, since the same tools can be used for the grooves 113 on all sash frame elements 107.1, 107.2 and 107.3.

A further significant advantage consists in the fact that each groove 117 on a sash frame element 107.1-107.3 lies in a common plane with the corresponding groove on the other sash frame elements, so that the seals in the grooves 117 of the sash frame elements 107.1-107.3 can be designed as continuous seals, thus providing an optimum seal when the sash 106 is in closed position.

FIGS. 14-16 depict cross sections similar to FIGS. 12-13, however with a sash frame 107a with the sash frame elements 107a.1, 107a.2 and 107a.3, which are formed from a multi-chamber plastic profile with an inner metal reinforcement 123. In this embodiment, all sash frame elements 107a.1, 107a.2 and 107a.3 are likewise provided with the groove 113 with the two recesses 116 and with the contact surfaces 113.3 formed by these recesses and with the additional grooves 117. In the sash frame element 107a.1 the groove 113 likewise serves essentially to hold the two running carriages 111, in the sash frame element 107a.2 for holding and fastening the strip-like forend rail 118 with the push rod 118 and in the sash frame element 107a.3 for holding the H-profile 121 with the guide element 122.

The invention was described above based on sample embodiments. It goes without saying that numerous modifications and variations are possible without abandoning the underlying inventive idea of the invention. For example, it is of course possible that the push rod 118 be used to actuate closing or locking elements or that such closing or locking elements be provided for on the push rod 118.

### REFERENCE Symbols

1 door/window frame

2 door sash

2.1 sash frame

3 lift-slide fitting

4 forend rail

5 gear unit

6 push rod

6.1 opening or hole

7 bearing element with corner transmission

8, 8a running shoe casing

9 running shoe

10, 11 wall of running shoe casing

11.1 reinforcement wall

12 roller

13 track or guide rail

13.1 sealing surface

14 lifting curve or opening

15 projection

16 guide or sliding bolts

17 coupling element

18, 19 guide surfaces for coupling element 17

20 tooth

21 connecting section

21.1 rounded surface

22 eyelet section

22.1 opening

23 bearing element for second running shoe

24 second running shoe

25 connection

25.1, 25.2 connecting rod

26 coupling section

27 groove

28 seal

29 sleeve opening

30 curved side section

31 corner areas

32 fixing element

101 door of building

102 door/window frame

103 fixed field

104 fixed field frame

105 fixed field glass

106 sash

107 sash frame

107.1, 107.2 sash frame

107.3, 107.4 sash frame element

107a.1, 107a.2 sash frame element

107a.3, 107a.4 sash frame element

108 sash frame glass

109 hand lever

110 gear unit

111 running carriage

112 running carriage roller

113 groove

113.1 bottom of groove

113.2 side surface of groove

113.3 contact surface

114 running carriage support

115 running carriage casing

116 recess

117 groove

118 forend rail

119 fastening means or fastening clip

120 push rod

121 H-profile

122 guide element

123 reinforcement

V vertical stroke

H horizontal stroke

K circular movement

\acute{a} angle

1. Fitting for lift-slide doors or windows with at least one running shoe (9) located on a bearing element (7) that can be moved for raising and lowering the door or window sash (2) in a longitudinal running shoe axis relative to the bearing element (7) and with a coupling element (17), which connects the at least one running shoe (9) for this movement with a drive element, for example a push rod (6), provided on one vertical section of the sash frame (2.1), characterized in that the coupling element (17) is a rigid, rod-like and/or push/pull type coupling element (17), which can be slided in the bearing element (7) and is connected at one first end with the drive element (6) and at the other end via a jointed connection with the running shoe (9).

2. Fitting as claimed in claim 1, characterized in that the casing (8) of the running shoe (9) is made of one piece, for example of metal, preferably of die-cast zinc.

3. Fitting for lift-slide doors or windows with at least one forend rail (118) and one push rod (6, 120) that can be moved axially on the forend rail, characterized in that the forend rail (4, 118) is flat or strip-shaped.

4. Fitting as claimed in claim 3, characterized by at least one running shoe (9) located on a bearing element (7) so that it can be moved on a longitudinal running shoe axis relative to the bearing element (7) for raising and lowering the door or window sash (2), and with a coupling element (17), which connects the at least one running shoe (9) for this movement with a drive element located on one vertical section of the sash frame (2.1), for example with a push rod (6), whereby the coupling element (17) is a rigid, rod-like and/or push/pull type coupling element (17), which is guided in the bearing element (7) and is connected at one end with the drive element (6) and at the other end via a jointed connection with the running shoe (9).

5. Fitting as claimed in claim 3, characterized by at least one running shoe (9) located on a bearing element (7) so that it can be moved in a longitudinal running shoe axis relative to the bearing element (7) for raising and lowering the door or window sash (2), and with a coupling element (17), which connects the at least one running shoe (9) for this movement with a drive element located on one vertical section of the sash frame (2.1), for example with a push rod (6), whereby the casing (8) of the running shoe (9) is made of one piece, for example of metal, preferably of die-cast zinc.

6. Fitting as claimed in one of the foregoing claims, characterized in that the coupling element (17) has the form of a partial ring or arc and is located in the bearing element (7) such that the ring axis is in a plane perpendicular to the door sash plane.

7. Fitting as claimed in one of the foregoing claims, characterized in that the coupling element (17) is designed as a rack and pinion on its first end and that this end engages with a toothed or perforated section (6.1) of the drive element (6).

8. Fitting as claimed in one of the foregoing claims, characterized in that the second end of the coupling element (17) is connected via a jointed connection with the running shoe (9) or a casing (8) of the running shoe (9).

9. Fitting as claimed in one of the foregoing claims, characterized in that the coupling element (17) engages with its other end in a coupling opening (22.1) of the running shoe (9) or of the running shoe casing (8).

10. Fitting as claimed in one of the foregoing claims, characterized by an arc-shaped guide (18, 19) in the bearing element (7) for the coupling element (17).

11. Fitting as claimed in one of the foregoing claims, characterized in that the coupling element (17) is manufactured as a preformed part made of metal or plastic.

12. Fitting as claimed in one of the foregoing claims, characterized in that the coupling element (17) has a profile that deviates from the circular form, for example a rectangular or square profile, at least between its two ends.

13. Fitting as claimed in one of the foregoing claims, characterized in that the bearing element (7) is designed as an elbow, i.e. with two legs (7.1, 7.2).

14. Fitting as claimed in claim 13, characterized in that the drive element (6) is guided on one leg and the running shoe (9) runs in bearings on the other end.

15. Fitting as claimed in claim 13 or 14, characterized in that the coupling element (17) is located in the area of the junction of the two legs (7.1, 7.2) in the bearing element (7).

16. Fitting as claimed in one of the foregoing claims, characterized in that the running shoe casing (8) has two walls (10) extending in the longitudinal direction of the running shoe and at a distance from each other, and that at least two rollers (12) can turn on bearings between the two walls (10).

17. Fitting as claimed in one of the foregoing claims, characterized in that the longitudinal walls (10) of the running shoe casing (8) are connected with each other at least on the ends of the running shoe by means of end walls (11).

18. Fitting as claimed in one of the foregoing claims, characterized in that at least one projection (15) forming a guide for the running shoe (9) is located on the bearing element (7).

19. Fitting as claimed in claim 18, characterized in that the at least one projection (15) extends into the running shoe casing (8) and forms lateral guide surfaces for inner surfaces of the running shoe casing (8).

20. Fitting as claimed in claim 18 or 19, characterized in that at least one lifting curve (14) is formed on the projection (8) with which (lifting curve) a guide or slide element (16) of the running shoe (9) works together.

21. Fitting as claimed in claim 20, characterized in that the lifting curve is formed by a recess (14).

22. Fitting as claimed in claim 20 or 21, characterized in that the slide element is a guide bolt (16).

23. Fitting for lift-slide doors or windows with at least one running shoe (9) located on a bearing element (7) so that it can be moved in a longitudinal running shoe axis relative to the bearing element (7) for raising and lowering the door or window sash (2), and with a coupling element (17), which connects the at least one running shoe (9) for this movement with a drive element located on one vertical section of the sash frame (2.1), for example with a push rod, characterized in that the casing (8) of the running shoe (9) is made of one piece with at least one sleeve-like coupling section (26) located on one end of the running shoe, manufactured for example of metal, preferably of die-cast zinc.

24. Fitting as claimed in claim 23, characterized in that the sleeve-like coupling section (26) has a sleeve opening (29) with a profile that is made up of a square profile form and a circular profile form such that it forms four sides with a cylindrical section (30) and four corner areas (31) with connecting right-angled surfaces, respectively, whereby the cylindrical sections (30) are located on a common imaginary cylinder surface around the center axis of the sleeve opening (29) and the radius of the cylindrical sections (30) is somewhat smaller than half the distance of two diagonally opposed corner areas (31), so that the respective sleeve-like coupling section (26) can be used alternately for a connecting rod (25.1, 25.2) with a circular or square profile.

25. Fitting as claimed in claim 23 or 24, characterized by means (32) for fixing the respective connecting rod (25.1, 25.2) in the sleeve opening (29).

26. Lift-slide door or window with at least one door or window sash (106) located in a door or window frame (102), with a running carriage or running shoes (111) located in a groove (113) on one lower, horizontal sash frame element (107.1, 107a.1) for raising and lowering and for sliding the sash (106), with a gear unit (110) located on one vertical sash frame element (107.2, 107a.2) that is connected with the running shoes (111) by means of a push rod (120) guided via a drive connection on a forend rail (118) for raising and lowering the sash (106), whereby the forend rail (118) is fastened to the push rod (120) in the area of a groove (113) on one sash frame element (107.2, 107a.2), characterized in that the forend rail (118) is designed as a flat or strip-shaped rail.

27. Lift-slide door or window as claimed in claim 26, characterized in that the push rod (120) has a flat or strip-shaped design.

28. Lift-slide door or window as claimed in claim 26 or 27, characterized in that the width of the forend rail is somewhat greater than the width of the push rod (120).

29. Lift-slide door or window as claimed in claim 28, characterized in that the groove (113) for fastening the forend rail (118) is provided with a recess (116) on both sides at its opening or the edge of its opening to form a contact surface (113.3) against which the forend rail (118) bears against edge areas and that the push rod (120) is contained in the groove (113).

30. Lift-slide door or window as claimed in one of the foregoing claims, characterized in that the groove (113) has a width that is the same or approximately the same as the width of the push rod (120).

31. Lift-slide door or window as claimed in one of the foregoing claims, characterized in that at least the groove (113) for containing the running carriage or running shoes (111) and the groove for fastening the forend rail (118) with the push rod (120) are designed identically.

32. Lift-slide door or window as claimed in one of the foregoing claims, characterized in that at least one further sash frame element forming the sash frame (107, 107a), preferably the sash frame element (107.3, 107a.3) forming the top of the sash (106) also has a groove (113) that is designed identically to the groove (113) for containing the running carriage or running shoes (111) and to the groove for fastening the forend rail (118) to the push rod (120).

33. Lift-slide door or window as claimed in claim 32, characterized in that a profile (121) with a guide element (122) is provided for in the groove (113) of the sash frame element (107.3, 107a.3) forming the top of the sash frame (107, 107a).

34. Lift-slide door or window as claimed in one of the foregoing claims, characterized in that the sash frame elements (107.1, 107.2, 107.3, 107.4) forming the sash frame (107) are profiles made of wood.

35. Lift-slide door or window as claimed in one of the foregoing claims, characterized in that the sash frame elements (107a.1, 107a.2, 107a.3, 107a.4) forming the sash frame (107a) are profiles made of plastic.
